(19) United States
(12) Patent Application Publication
(10) Pub. No.: US 2012/0163639 A1
(43) Pub. Date: Jun. 28, 2012

(54) HEARING AID

(76) Inventor: Gempo ITO, Kanagawa (JP)

(21) Appl. No.: 13/323,067

(22) Filed: Dec. 12, 2011

(30) Foreign Application Priority Data
Dec. 24, 2010 (JP) 2010-287414

(51) Int. Cl. H04R 25/00

(52) U.S. Cl. 381/313; 381/312; 381/321; 381/317

(57) ABSTRACT

A hearing aid that prevents the user from missing new speech when listening again to recorded speech. This hearing aid comprises a speech input section, a speech buffer, first and second direction adjustment sections, a hearing aid processor, and a speech output section. The speech input section inputs a speech signal. The speech buffer holds a speech signal inputted to the speech input section. The first and second direction adjustment sections subject a first speech signal inputted to the speech input section and/or a second speech signal held in the speech buffer to speech processing such that the first speech signal and the second speech signal are each perceived independently. The hearing aid processor subjects signals outputted from the first and second direction adjustment sections to hearing aid processing. The speech output section outputs a speech signal that has undergone hearing aid processing at the hearing aid processor.

### FIELD OF THE INVENTION

1. Field of the Invention

The present invention relates to a hearing aid having a function of recording inputted speech.

2. Description of the Related Art

A hearing aid with which an inputted speech signal is recorded and reproduced so that the user can again listen to speech that was missed the first time in real time has been known in recent years (see Patent Literature 1).

### CITATION LIST

### Patent Literature

Patent Literature 1: Japanese Laid-Open Patent Application H5-56499 (laid open Mar. 5, 1993)

Non-Patent Literature 1: “Spatial Hearing,” by Jens Blauert, Masayuki Morimoto, and Toshiyuki Goto, Kajima Publishing, Jul. 10, 1986

Non-Patent Literature 2: James M. Kates, “Digital Hearing Aids,” Plural Publishing (Mar. 31, 2008), No. 99

### SUMMARY

### Problem to be Solved by the Invention

However, the following problem was encountered with the above-mentioned conventional hearing aid.

Specifically, with the above-mentioned conventional hearing aid, if the user misses speech, he plays back the speech at low speed so that he can properly hear the missed speech. However, while he is playing back the recorded speech, the hearing aid user will have difficulty hearing speech that is inputted to the hearing aid in real time, so the user may miss more speech.

It is an object of the present invention to provide a hearing aid with which it is possible to prevent the user from missing new speech when listening again to recorded speech.

### Means for Solving Problem

The hearing aid pertaining to a first invention comprises a speech input section, a speech memory section, a speech processor, a hearing aid processor, and a speech output section. The speech input section inputs a speech signal. The speech memory section holds a speech signal inputted to the speech input section. The speech processor subjects a first speech signal inputted to the speech input section and/or a second speech signal held in the speech memory section to speech processing such that the first speech signal and the second speech signal are each perceived independently. The hearing aid processor subjects a signal outputted from the speech processor to hearing aid processing. The speech output section outputs a speech signal that has undergone hearing aid processing at the hearing aid processor.

Here, with hearing aid equipped with a recording function, a speech signal that is inputted in real time (first speech signal) and a speech signal that was previously inputted and recorded (second speech signal) are subjected to speech processing and outputted so that each is independently perceived by the user.

The above-mentioned speech processing could be, for example, processing in which a differential is imparted to the output volume or the direction of speech (direction of generation source) approached by the user.

Consequently, when the user listens again to speech that he missed hearing just earlier, he can distinguish between the speech being reproduced that he wants to hear again, and the speech that is being inputted in real time while he is listening again to the earlier speech. As a result, for example, this allows the user to reliably hear the speech being repeated, prevents the user from missing new speech, and also prevents the user from missing sounds indicating danger and other such sound being inputted in real time.

The hearing aid pertaining to a second invention is the hearing aid pertaining to the first invention, wherein the speech processor performs direction adjustment processing so that the first speech signal and the second speech signal are perceived by the user as being speech from different directions.

Here, the above-mentioned first and second speech signals are each subjected direction adjustment processing so that the user perceives them as being speech that is heard from different directions.

Consequently, the user can distinguish and recognize the speech he wants to listen to again, from the speech that is being inputted in real time.

The hearing aid pertaining to a third invention is the hearing aid pertaining to the second invention, wherein the speech processor performs direction adjustment processing so as to subject the first speech signal to directional processing in the lateral direction, and subject the second speech signal to directional processing in the front direction.

Here, in order for the user to be able to preferentially hear speech that the user wants to listen to again (second speech signal), direction adjustment processing is performed on the second speech signal so that the user perceives it to be speech from the front direction, which is easier to concentrate on, and the first speech signal with a lower priority is subjected to direction adjustment processing so that the user perceives the speech to be from his lateral direction.

Consequently, the user can preferentially concentrate on and hear the speech of the second speech signal that he is listening to again, and can also hear the speech of the first speech signal being inputted in real time.

The hearing aid pertaining to a fourth invention is the hearing aid pertaining to the second or third invention, wherein the direction adjustment processing includes directivity control processing in which sound is picked up with directionality in the desired direction.

Here, directivity control processing is used as the above-mentioned direction adjustment processing.

Consequently, for example, the second speech signal is subjected to pickup processing with directionality in the front direction of the user, while the first speech signal is subjected to pickup processing with directionality in the lateral direction of the user, which allows the user to distinguish and hear the speech corresponding to the first and second speech signals.

The hearing aid pertaining to a fifth invention is the hearing aid pertaining to any of the first to fourth inventions, wherein the speech processor performs volume adjustment processing so that the output level of the first speech signal will be lower than the output level of the second speech signal.

Here, the first and second speech signals are subjected to volume adjustment processing in which a differential is imparted to the output level so that the user can distinguish and hear the first and second speech signals.

The speech processing on the first and second speech signals may be such that the above-mentioned direction adjustment processing and this speech adjustment processing are performed selectively, or the two may be combined.

Consequently, the user can distinguish and hear the speech corresponding to the first and second speech signals, and can preferentially hear speech with a higher priority.

The hearing aid pertaining to a sixth invention is the hearing aid pertaining to any of the first to fifth inventions, wherein the hearing aid processor subjects the first speech signal and the second speech signal each to different hearing aid processing.

Here, in addition to the above-mentioned speech processing, the first and second speech signals are also subjected to different hearing aid processing.

Consequently, the user can more easily determine the speech corresponding to each of the first and second speech signals.

The hearing aid pertaining to a seventh invention is the hearing aid pertaining to the sixth invention, wherein the hearing aid processor performs hearing aid processing so as to eliminate a noise part from the second speech signal.

Here, noise elimination processing of the second speech signal is performed as the above-mentioned hearing aid processing.

Consequently, speech corresponding to the second speech signal that the user wants to listen to again can be heard with better sound quality, and this also prevents the user from missing sounds indicating danger and other such sound corresponding to the first speech signal.

### Effects

With the hearing aid pertaining to the present invention, the user can be prevented from missing new speech while listening again to recorded speech with a hearing aid having a recording function.

### BRIEF DESCRIPTION OF DRAWINGS

FIG. 1 is a control block diagram of the configuration of the hearing aid pertaining to an embodiment of the present invention;

FIG. 2 is a flowchart of the flow of control in the hearing aid in FIG. 1;

FIG. 3A is a concept diagram of a state in which the hearing aid in FIG. 1 has been put on by a user, and FIG. 3B is a concept diagram of a state in which a button is pressed to change the hearing aid in FIG. 1 to its repeat mode;

FIGS. 4A and 4B are diagrams illustrating the setting of the direction of the user in which recorded speech and speech being inputted in real time are perceived;

FIG. 5 is a control block diagram of the configuration of the hearing aid pertaining to another embodiment of the present invention;

FIG. 6 is a control block diagram of when a plurality of microphones are installed in the hearing aid in FIG. 5;

FIG. 7 is a control block diagram of when a plurality of microphones are installed in the hearing aid in FIG. 5;

FIG. 8 is a control block diagram of the configuration of the hearing aid pertaining to yet another embodiment of the present invention;

FIG. 9 is a flowchart of the flow of control in the hearing aid in FIG. 8;

FIG. 10 is a control block diagram of the configuration of the hearing aid pertaining to yet another embodiment of the present invention;

FIG. 11 is a control block diagram of when a plurality of microphones are installed in the hearing aid of FIG. 10; and

FIG. 12 is a control block diagram of when a plurality of microphones are installed in the hearing aid of FIG. 10.

### DETAILED DESCRIPTION OF THE INVENTION

### Embodiment 1

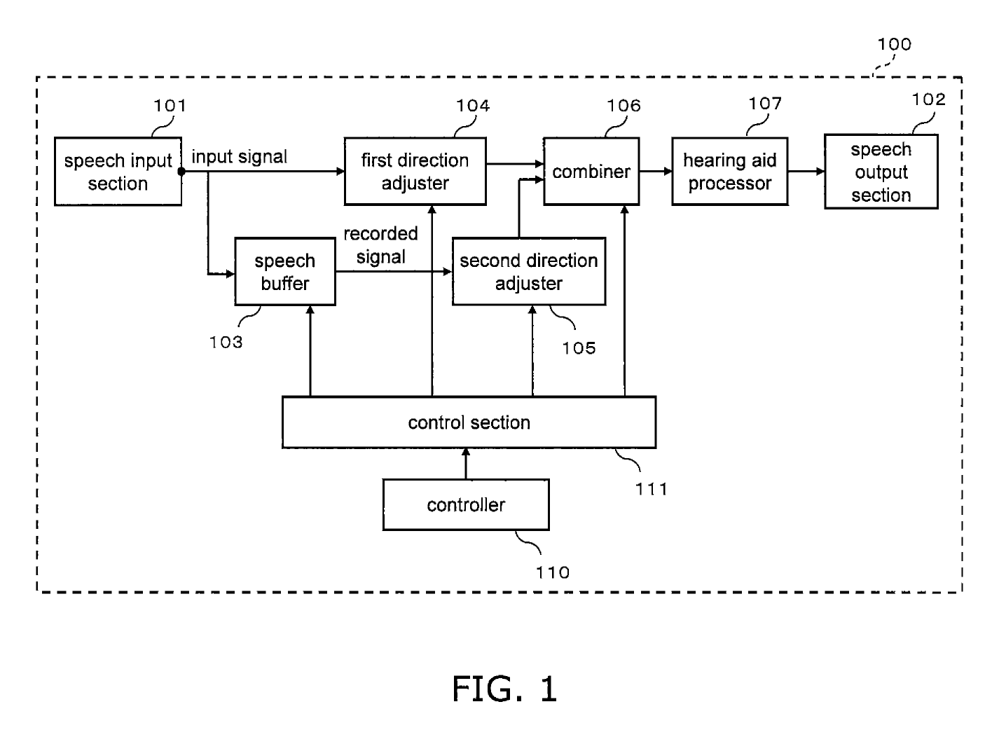

FIG. 1 is a control block diagram of the configuration of a hearing aid 100 pertaining to Embodiment 1 of the present invention.

As shown in FIG. 1, the hearing aid 100 of this embodiment comprises a speech input section 101, a speech output section 102, a speech buffer (speech memory section) 103, a first direction adjuster (speech processor) 104, a second direction adjuster (speech processor) 105, a combiner 106, a hearing aid processor 107, a controller 110, and a control section 111.

The speech input section 101 inputs a speech signal outputted from one or more microphones of the hearing aid 100, a speech signal outputted from a speech reproduction device, or the like.

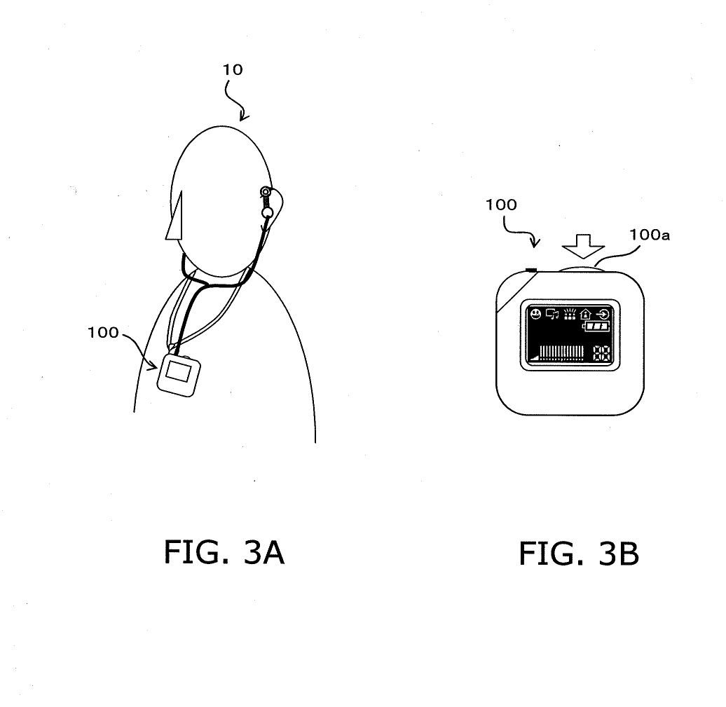

The controller 110 accepts manipulation by a user 10 (see FIG. 3A) or another device, and outputs manipulation information to the control section 111.

The control section 111 controls the operation of the speech buffer 103, the first direction adjuster 104, the second direction adjuster 105, and the combiner 106 on the basis of the manipulation information inputted from the controller 110.

The speech buffer 103 records a speech signal inputted to the speech input section 101 on the basis of control by the control section 111. The speech buffer 103 also sequentially outputs a specified portion of the recorded speech signal as recorded speech.

The first direction adjuster 104 subjects the speech signal outputted from the speech input section 101 (first speech signal) to direction adjustment processing for adjusting the direction of sound which is perceived by the user 10, on the basis of control by the control section 111.

The second direction adjuster 105 subjects the recorded speech signal outputted from the speech buffer 103 (second speech signal) to direction adjustment processing for adjusting the direction of sound which is perceived by the user 10, on the basis of control by the control section 111.

The combiner 106 combines and outputs the speech signal outputted from the first direction adjuster 104 and/or the second direction adjuster 105 after performing volume adjustment, on the basis of control by the control section 111.

The hearing aid processor 107 subjects the signal outputted from the combiner 106 to nonlinear amplification, noise suppression, or other such hearing aid processing, and outputs the result.

The speech output section 102 outputs the signal processed by the hearing aid processor 107.

Operation of Hearing Aid 100

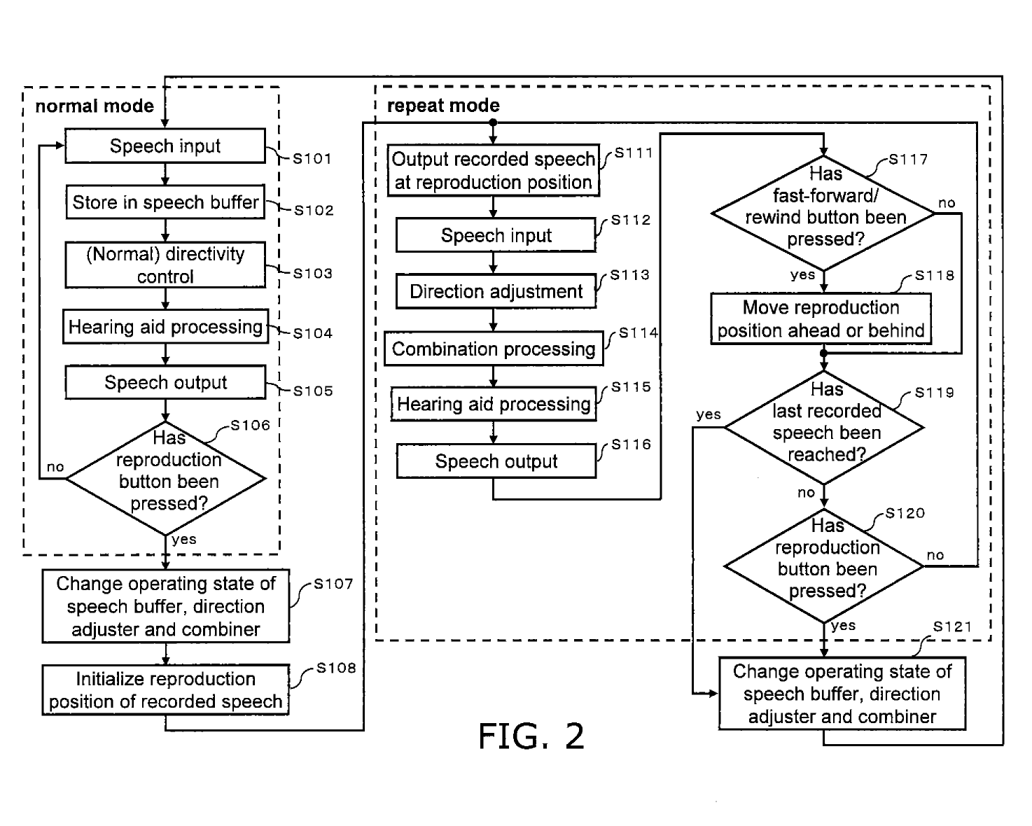

An example of the operation of the hearing aid 100 in this embodiment will be described through reference to the flowchart in FIG. 2.

In the drawing, the operating state of the hearing aid 100 in this embodiment is broadly classified into two states, indicated as “normal mode” and “repeat mode.”

In normal mode, when a speech signal is inputted to the speech input section 101 (S101), the speech buffer 103 sequentially records the inputted speech signal (S102). If the recording region had by the speech buffer 103 is completely used up, it may be over-written in order starting from the oldest part.

Next, the first direction adjuster 104 subjects the speech signal outputted from the speech input section 101 (first speech signal) to ordinary directivity control processing (S103). At this point the combiner 106 directly outputs the speech signal outputted from the first direction adjuster 104.

The hearing aid processor 107 subjects a speech signal that has undergone directivity control processing to nonlinear amplification, noise suppression, or other such hearing aid processing, and outputs the result (S104).

The speech output section 102 outputs a signal that has undergone hearing aid processing from a receiver or other reproduction device of the hearing aid 100 (S105).

Here, the controller 110, as shown in FIGS. 3Aa and 3B, confirms whether or not there has been an operation requesting the repeat of a recorded speech signal, such as when the user 10 presses a button 100a on the hearing aid 100. If a request for speech repeat is confirmed, the controller 110 outputs manipulation information for changing to repeat mode. Otherwise, the flow returns to S101 and operation in normal mode continues (S106).

When manipulation information for changing to repeat mode is inputted, the control section 111 outputs a control signal for changing the operation to repeat mode to the speech buffer 103, the first direction adjuster 104, the second direction adjuster 105, and the combiner 106 (S107).

The control section 111 also outputs a control signal to the speech buffer 103 for initializing the reproduction position to a specific position (S108). Here, the “specific position” may be the reproduction position prior a specific length of time ago (such as about 10 to 20 seconds ago), or may be a position that was predetermined by the user.

In repeat mode, the speech buffer 103 sequentially outputs a recorded speech signal (second speech signal) from the reproduction position designated by the control section 111 (S111).

At this point, when a speech signal is inputted in real time to the speech input section 101 (S112), the first direction adjuster 104 subjects the speech signal outputted from the speech input section 101, and the second direction adjuster 105 subjects the recorded speech signal outputted from the speech buffer 103, to direction adjustment processing for adjusting the directions in which the user 10 perceives sounds, respectively (S113).

The combiner 106 subjects the speech signals outputted from the first direction adjuster 104 and the second direction adjuster 105 to volume adjustment, and then combines the signals (S114).

For example, the recorded speech signal outputted from the second direction adjuster 105 is set to be louder so that the speech signal the user wants to hear again can be heard clearly, while the speech outputted from the first direction adjuster 104 is set to be softer, but still loud enough for a sound indicating danger (such as the sound of an approaching car) can be perceived. Consequently, the necessary information can be obtained from both of the sounds, and at the same time the user can identify which of the sounds he hears is the speech signal being repeated.

The hearing aid processor 107 subjects the speech signal outputted from the combiner 106 to hearing aid processing such as nonlinear amplification or noise suppression, and outputs the result (S115). The speech output section 102 then outputs the speech signal that has undergone hearing aid processing from a receiver or other reproduction device of the hearing aid 100 (S116).

The hearing aid processor 107 may be set so that it subjects the recorded speech signal outputted from the second direction adjuster 105 to hearing aid processing that eliminates noise so that the speech signal the user wants to hear again can be heard clearly, and performs normal hearing aid processing on the speech signal outputted from the first direction adjuster 104. Alternatively, a differential may be provided between the recorded speech signal outputted from the second direction adjuster 105 and the speech signal outputted from the first direction adjuster 104, to the extent that hearing aid processing for eliminating noise can be performed. This allows the user to hear the repeated speech more clearly than other sounds.

Here, the controller 110 confirms whether or not there has been a request to fast-forward or rewind a recorded speech signal, such as when the user 10 presses the button 100a on the hearing aid 100. If a request from the user 10 for fast-forward or rewind is confirmed, the controller 110 outputs manipulation information for fast-forward or rewind. Otherwise, the flow returns to S119 (S117).

When fast-forward or rewind play manipulation information is inputted, the control section 111 outputs a control signal to the speech buffer 103 so as to change the reproduction position (S118). More specifically, a control signal to change the reproduction position is outputted ahead when fast-forward manipulation information is inputted, and in back when rewind manipulation information is inputted. The amount by which the reproduction position is changed may be a specific length of time, or it may be varied according to the state of button manipulation.

For example, if the button 100a is pressed and then immediately released, a change of a specific length of time (such as about 1 to 10 seconds) may be made with a single press of the button, and if the button 100a is held down, a continuous change may be made in an amount corresponding to fast-forward or rewind in an ordinary audio player (such as about 1.5 to 10 times the normal speed).

Next, when the last recorded speech signal is reached, the flow proceeds to S121, and otherwise proceeds to S120 (S119).

The controller 110 at this point confirms whether or not a request to return to normal hearing aid processing has been made by the user by pressing the button 100a of the hearing aid 100, for example. If a request to return to normal hearing aid processing is confirmed here, the controller 110 outputs manipulation information for shifting to normal mode. Otherwise, the flow returns to S111 and operation in repeat mode continues (S120).

When the last recorded speech is reached in S119, or manipulation information for changing to normal mode is inputted, the control section 111 outputs a control signal for changing the operation to normal mode to the speech buffer 103, the first direction adjuster 104 and the combiner 106 (S121).

Direction Adjustment Processing

The operation of the first direction adjuster 104 and the second direction adjuster 105 in S113 will now be described in detail.

If the interaural time difference (ITD) calculated from speech inputted to both ears of the user 10 is small, then that speech is perceived as being close to the front middle of the user 10 (see Non-Patent Literature 1). Therefore, speech can be made to be perceived as being close to the middle, that is, concentrated speech coming from the front or rear of the user 10, by performing direction adjustment processing so as to reduce the interaural time difference.

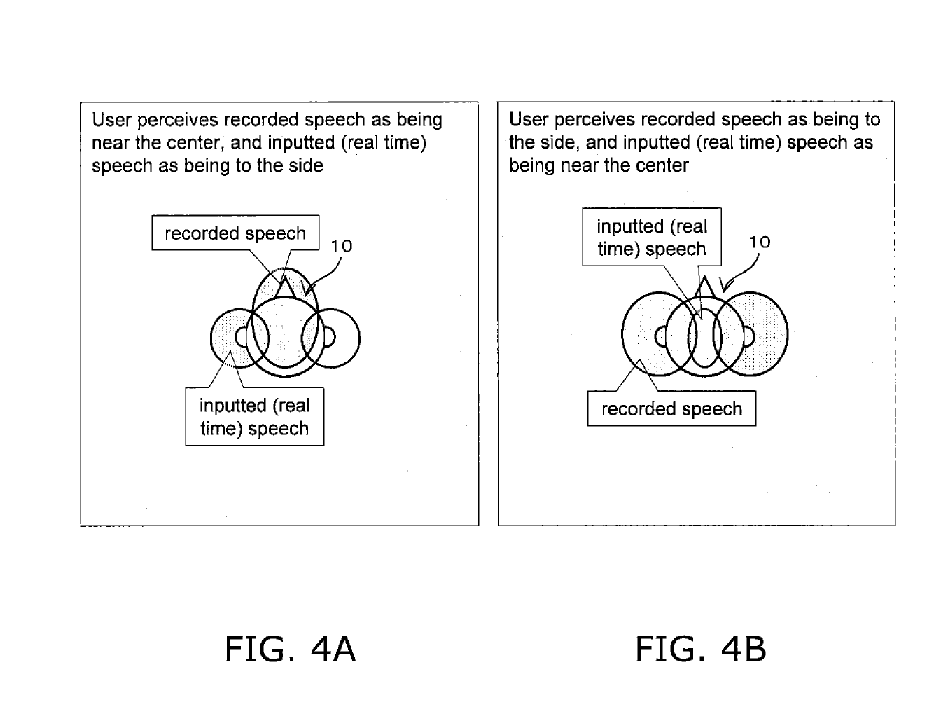

For example, as shown in FIG. 4A, direction adjustment is performed so that the recorded speech signal outputted from the speech buffer 103 is perceived as speech from close to the middle of the user 10, and the speech signal outputted from the speech input section 101 as speech from the side of the user 10. Consequently, the user 10 can easily focus his attention so that he can preferentially hear repeated speech by setting the repeated speech to be near the middle of the user 10.

Conversely, as shown in FIG. 4B, direction adjustment may be performed so that the speech signal inputted to the speech input section 101 is perceived as speech from close to the middle of the user 10, and the recorded speech signal outputted from the speech buffer 103 as speech from the side of the user 10. Consequently, the user 10 can easily find the sound he wants to hear from among the recorded speech, taking advantage of the spatial separation capability of sound (cocktail party effect).

As to controlling the above-mentioned direction adjustment, either of the states shown in FIGS. 4A and 4B may be set, or the setting may allow switching between the two.

In this embodiment, as discussed above, the recorded speech signal outputted from the speech buffer 103 and the speech inputted in real time to the speech input section 101 are subjected to direction adjustment processing so that each is perceived as speech coming from a different direction.

Consequently, when recorded speech is repeated, the user can clearly hear the speech he wants to repeat, and can simultaneously detect sounds indicating danger in real time.

In this embodiment, an example was given in which speech inputted in real time and speech that has been recorded are subjected to direction adjustment processing, which allows the user to independently perceive speech inputted in real time and speech that has been recorded. The present invention is not limited to this, however.

For example, rather than subjecting speech inputted in real time and speech that has been recorded to direction adjustment processing, just processing that adjusts volume can be performed to obtain the above-mentioned effect.

### Embodiment 2

A hearing aid 200 pertaining to another embodiment of the present invention will now be described.

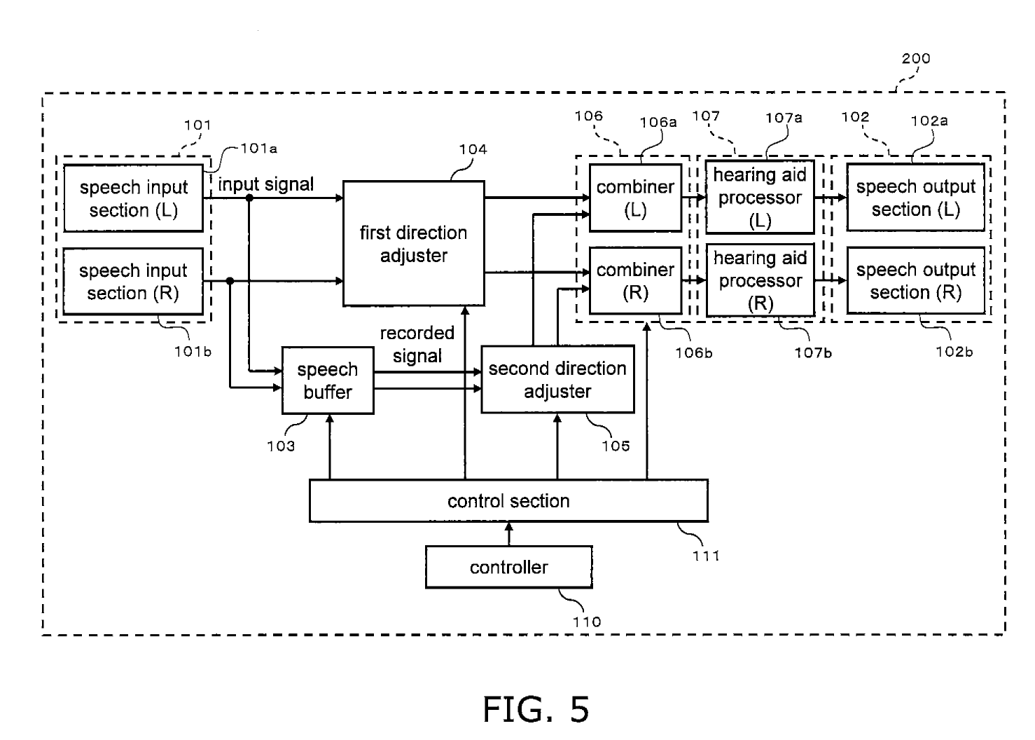

Of the constituent elements shown in FIGS. 5 to 7, those that are the same as in FIG. 1 and described in Embodiment 1 above will be numbered the same and not described again.

As shown in FIG. 5, for example, the hearing aid 200 in this embodiment differs from the hearing aid 100 of Embodiment 1 above in that it is configured as a binaural hearing aid.

As shown in FIG. 5, with the hearing aid 200 mounted on the left and right ears in this embodiment, the speech input section 101 has speech input sections 101a and 101b to which left- and right-ear speech is inputted. Similarly, the speech output section 102, the combiner 106, and the hearing aid processor 107 have left- and right-ear speech output sections 102a and 102b, combiners 106a and 106b, and hearing aid processors 107a and 107b, respectively.

The speech buffer 103 records and outputs the speech signals inputted from the two speech input sections 101a and 101b.

The first direction adjuster 104 and the second direction adjuster 105 subject the two speech signals inputted from the speech input sections 101a and 101b and the speech buffer 103 to direction adjustment processing, respectively.

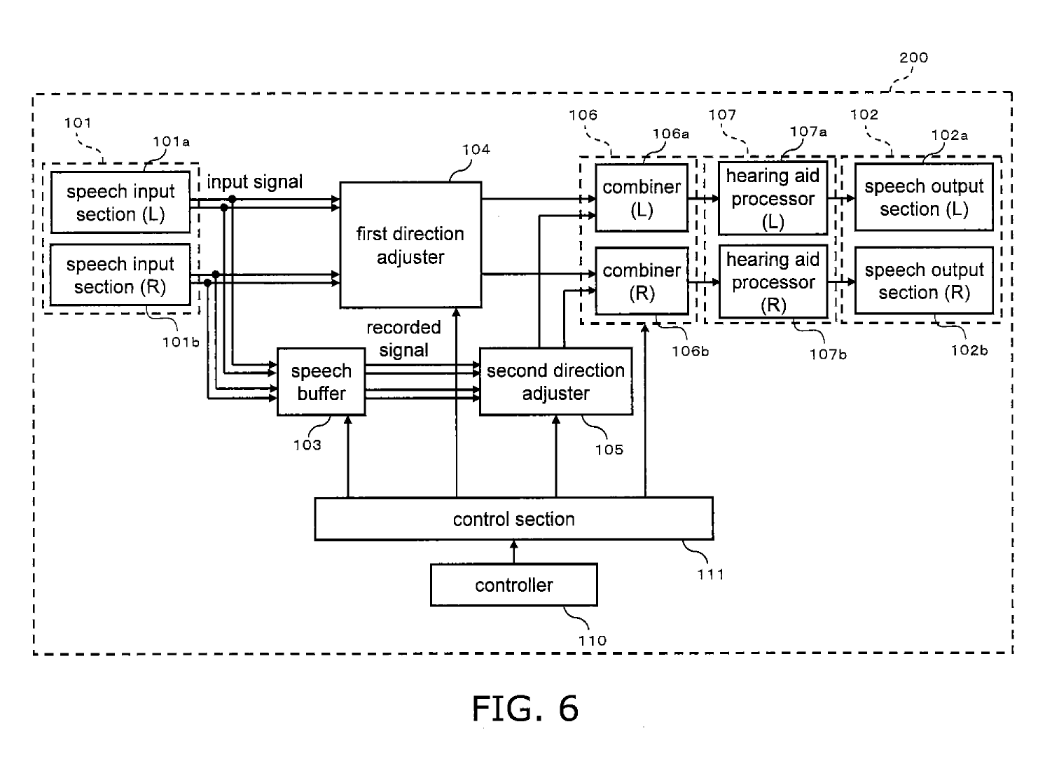

If, as in this embodiment, a plurality of (two in this embodiment) microphones are mounted on the left and right parts of the binaural hearing aid 200, as shown in FIG. 6, the speech buffer 103 may record and output the plurality of speech signals inputted from the speech input sections 101a and 101b, and the first direction adjuster 104 and the second direction adjuster 105 may subject the plurality of speech signals inputted from the speech input sections 101a and 101b and the speech buffer 103 to direction adjustment processing.

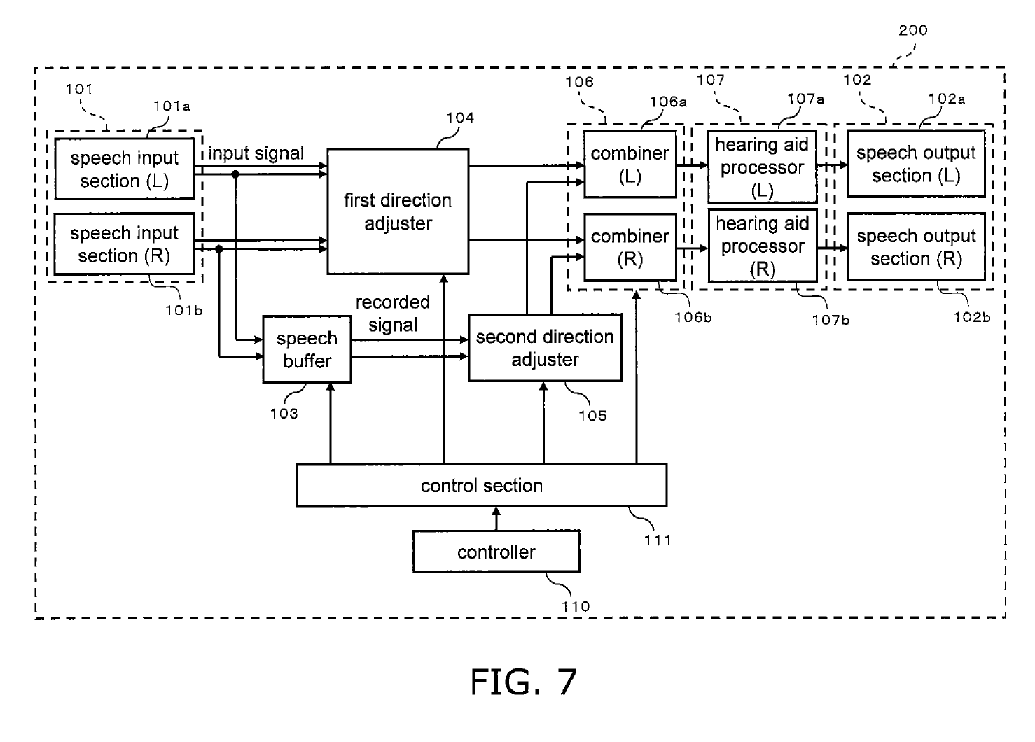

The speech acquired by the plurality of microphones is used when performing directivity control processing or the like (see Non-Patent Literature 2). If there is no need to subject the recorded speech signals to directivity control processing, as shown in FIG. 7, the speech buffer 103 may record and output one of each of the plurality of speech signals inputted from the speech input sections 101a and 101b.

With this binaural hearing aid 200, as shown in the following Formula 1, the left and right sections can be added up in specific ratios to bring the speech closer to a monaural state and reduce the interaural time difference during hearing.

Yₗ(t)=αXₗ(t)+(1−α)Xᵣ(t), Yᵣ(t)=(1−α)Xₗ(t)+αXᵣ(t) Formula 1

where 0.5≦α<1

and:

Xₗ(t): input to the left ear, Xᵣ(t): input to the right ear

Yₗ(t): output to the left ear, Yᵣ(t): output to the right ear

Alternatively, as shown in FIGS. 6 and 7, if the hearing aid 200 comprises a plurality of microphones placed close together, the user can similarly concentrate on and perceive the speech from close to the middle of the user by performing directivity control processing in which sound is picked up from in front or behind (or in which sound from the side is excluded).

Conversely, the user 10 will be able to perceive speech that he has heard as being speech from somewhere other than the middle, by reducing the section with a small interaural time difference.

With the binaural hearing aid 200 of this embodiment shown in FIGS. 5 to 7, for example, speech that is heard can be perceived by the user 10 to be speech from somewhere other than the middle of the user by means of processing in which the positive or negative sign of the left or right speech signal is inverted, processing in which the left and right signals are uncorrelated, etc.

Alternatively, as shown in FIGS. 6 and 7, if the hearing aid 200 comprises a plurality of microphones that are close together, speech that has been heard can be similarly perceived by the user 10 to be speech from somewhere other than the middle of the user 10, by picking up sound from the side (or excluding sound from in front or behind), etc.

With the hearing aid 200 of the present invention, as discussed above, the recorded speech signal outputted from the speech buffer 103 and the speech signal inputted from the speech input section 101 are subjected to direction adjustment processing so that they are perceived as speech coming from different directions, which allows the speech of both to be heard clearly.

### Embodiment 3

A hearing aid 300 pertaining to yet another embodiment of the present invention will now be described.

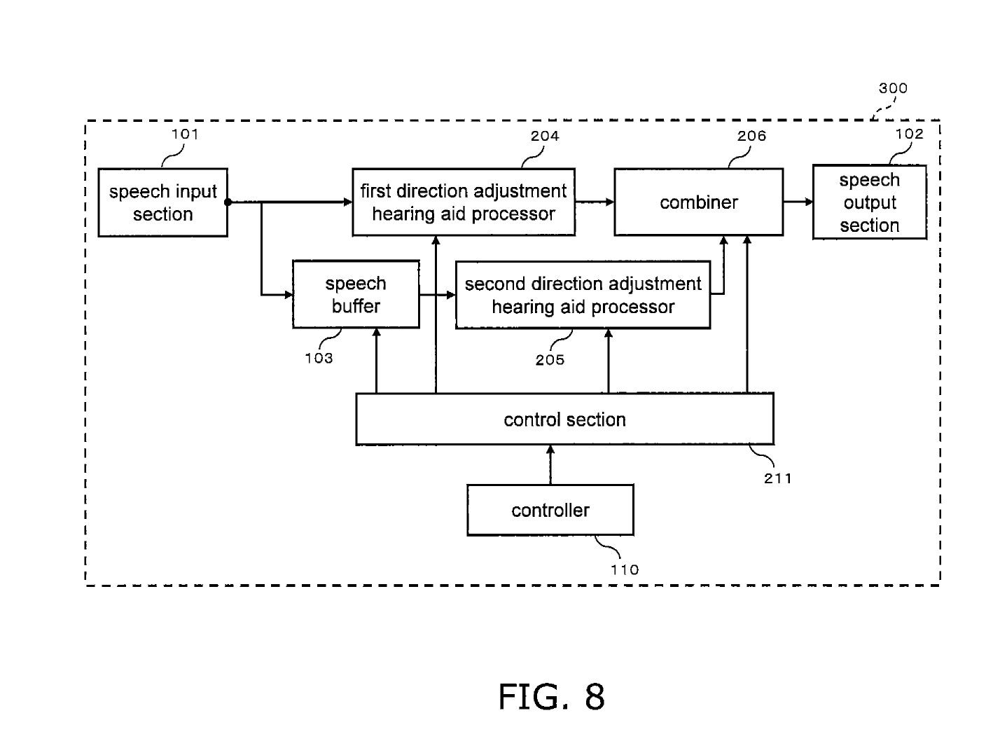

FIG. 8 is a control block diagram of the configuration of the hearing aid 300 of this embodiment. Of the constituent elements shown in FIG. 8, those that are the same as in FIG. 1 and described in Embodiment 1 above will be numbered the same and not described again.

In FIG. 8, a control section 211 controls a speech buffer 103, a first direction adjustment hearing aid processor (speech processor) 204, a second direction adjustment hearing aid processor (speech processor) 205, and a combiner 206 on the basis of manipulation information outputted from a controller 110. That is, this embodiment differs from Embodiment 1 above in that a recorded speech signal and a speech signal obtained in real time are separately subjected to direction adjustment hearing aid processing.

The speech buffer 103 records a speech signal inputted from the speech input section 101 on the basis of control by the control section 211. The speech buffer 103 also sequentially outputs a specified portion of the recorded speech signal.

The first direction adjustment hearing aid processor 204 subjects the speech signal outputted from the speech input section 101 (first speech signal) to direction adjustment processing for adjusting the direction of sound which is perceived by the user 10, as well as nonlinear amplification, noise suppression, or other such hearing aid processing, and outputs the result.

The second direction adjustment hearing aid processor 205 subjects the recorded speech signal outputted from the speech buffer 103 (second speech signal) to direction adjustment processing for adjusting the direction of sound which is perceived by the user 10, as well as nonlinear amplification, noise suppression, or other such hearing aid processing, and outputs the result.

The combiner 206 combines and outputs the speech signal outputted from the first direction adjustment hearing aid processor 204 and/or the second direction adjustment hearing aid processor 205 after performing volume adjustment, on the basis of control by the control section 211.

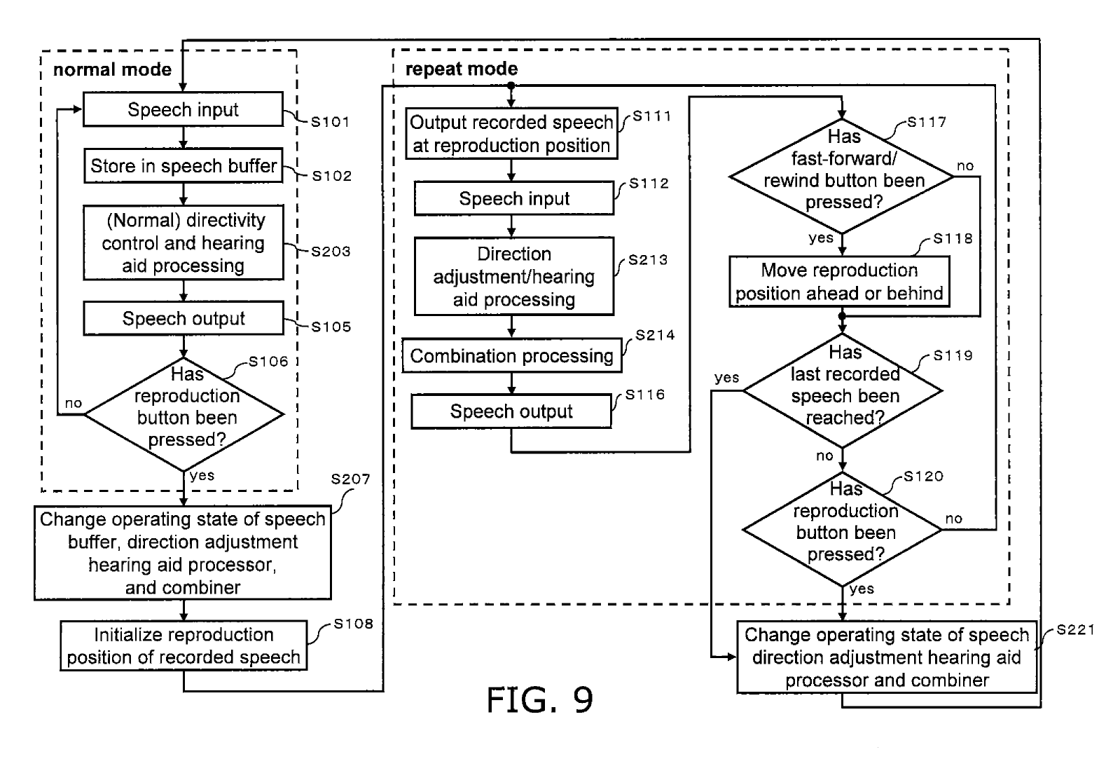

An example of the operation of the hearing aid 300 shown in FIG. 8 will be described through reference to the flowchart in FIG. 9. In FIG. 9, those steps that are the same as in the flowchart of FIG. 2 will be numbered the same and will not be described again.

In normal mode, when a speech signal is inputted to the speech input section 101 (S101), the speech buffer 103 sequentially records the inputted speech signal (S102).

Next, the first direction adjustment hearing aid processor 204 subjects the speech signal outputted from the speech input section 101 to ordinary directivity control processing and to hearing aid processing including nonlinear amplification, noise suppression, and so on (S203).

The combiner 206 directly outputs just the speech signal that has undergone hearing aid processing, and the speech output section 102 outputs the speech signal outputted from the combiner 206, from a receiver or other reproduction device of the hearing aid 300 (S105).

Here, the controller 110 confirms whether or not there has been an operation requesting the repeat of recorded speech, such as when the user 10 presses a button on the hearing aid 300. If a request for speech repeat is confirmed, the controller 110 outputs manipulation information for changing to repeat mode. Otherwise, the flow returns to S101 and operation in normal mode continues (S106).

When manipulation information for changing to repeat mode is inputted, the control section 211 outputs a control signal for changing the operation to repeat mode to the speech buffer 103, the first direction adjustment hearing aid processor 204, the second direction adjustment hearing aid processor 205, and the combiner 206 (S207). The control section 211 also outputs a control signal to the speech buffer 103 for initializing the reproduction position to a specific position (S108).

In repeat mode, the speech buffer 103 sequentially outputs recorded speech from the reproduction position designated by the control section 211 (S111).

Next, when speech is inputted from the speech input section 101 (S112), the first direction adjustment hearing aid processor 204 subjects the inputted speech signal to direction adjustment processing for adjusting the directions in which the user 10 perceives sounds, as well as nonlinear amplification, noise suppression, or other such hearing aid processing, and outputs the result. Similarly, the second direction adjustment hearing aid processor 205 subjects the recorded speech signal outputted from the speech buffer 103 to direction adjustment processing and hearing aid processing, and outputs the result (S213).

At this point the second direction adjustment hearing aid processor 205 may perform additional processing, besides the direction adjustment processing described in Embodiment 1 above, such as speech emphasis for emphasizing a person's voice so that the speech the user wants to heard can be more easily heard from among the recorded speech.

Also, besides the direction adjustment processing described in Embodiment 1 above, the first direction adjustment hearing aid processor 204 also may perform processing for emphasizing sounds indicating danger (such as emphasis on abrupt sounds) so that the user may more easily detect sounds indicating danger included in sound signals that are inputted in real time.

Thus, because the first and second direction adjustment hearing aid processor 204 and 205 each perform different hearing aid processing, speech that the user wants to hear again in repeating recorded speech can be heard clearly, and sounds indicating danger inputted in real time can be detected right away more easily.

The combiner 206 combines the speech signals outputted from the first direction adjustment hearing aid processor 204 and the second direction adjustment hearing aid processor 205 after performing volume adjustment, and outputs the result (S214).

The speech output section 102 then outputs the signal outputted from the combiner 206, via a receiver or other reproduction device of the hearing aid 300 (S116).

Here, the controller 110 confirms whether or not there has been an operation requesting that a recorded speech signal be fast-forwarded or rewound, such as when the user 10 presses a button on the hearing aid 300. If a request for fast-forward or rewind is confirmed, the controller 110 outputs manipulation information for fast-forward or rewind. Otherwise, the flow proceeds to S119 (S117).

When manipulation information for fast-forward or rewind is inputted, the control section 111 outputs a control signal for changing the reproduction position to the speech buffer 103 (S118).

Next, when the last recorded speech signal is reached, the flow proceeds to S221, and otherwise proceeds to S120 (S119).

The controller 110 at this point confirms whether or not a request to return to normal hearing aid processing has been made by the user by pressing a button on the hearing aid 300. If a request to return to normal hearing aid processing is confirmed here, the controller 110 outputs manipulation information for shifting to normal mode. Otherwise, the flow returns to S111 and operation in repeat mode continues (S120).

If either the last recorded speech signal is reached in S119 or manipulation information is inputted for shifting to normal mode, the control section 211 outputs a control signal for changing the operation to normal mode to the speech buffer 103, the first direction adjustment hearing aid processor 204, the second direction adjustment hearing aid processor 205, and the combiner 206 (S221).

In this embodiment, as discussed above, the recorded speech signal outputted from the speech buffer 103 (second speech signal) and the speech signal outputted from the speech input section 101 (first speech signal) are subjected to direction adjustment processing so that speech will be perceived as coming from different directions, and to different hearing aid processing, and these signals are then combined and outputted.

Consequently, when the user listens to recorded speech again, he can clearly hear just the speech he wants to hear again, and can also easily detect sounds indicating danger and the like inputted in real time.

The directivity control processing and hearing aid processing may be varied as desired in their details according to the hearing aid adjustment work (called fitting), the environment in which the hearing aid will be used, and so forth. For instance, the first direction adjuster 104, the first direction adjustment hearing aid processor 204, and the second direction adjustment hearing aid processor 205 may not perform directivity control processing, and instead directly output the inputted speech.

### Embodiment 4

The hearing aid 400 pertaining to yet another embodiment of the present invention will now be described.

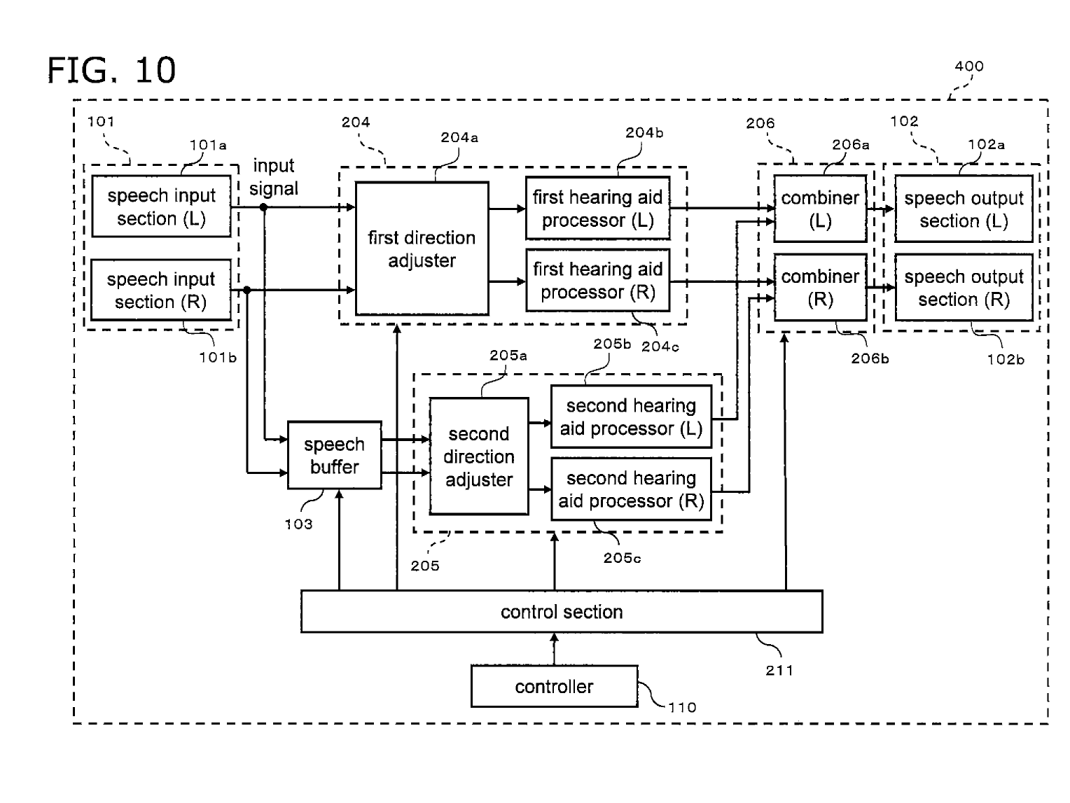

FIGS. 10 to 12 are control block diagrams of the configuration of the hearing aid 400 of this embodiment. Of the constituent elements shown in FIGS. 10 to 12, those that are the same as in FIG. 1 and described in Embodiment 1 above will be numbered the same and not described again.

As shown in FIG. 10, when the hearing aid 300 of Embodiment 3 above is used as the binaural hearing aid 400, the speech input section 101 may have speech input sections 101a and 101b to which left- and right-ear speech is inputted. Similarly, the speech output section 102 and the combiner 206 may have speech output sections 102a and 102b and combiners 206a and 206b, respectively.

In this case, the speech buffer 103 may record and output speech signals outputted from the two speech input sections 101a and 101b.

Also, the first direction adjustment hearing aid processor 204 and the second direction adjustment hearing aid processor 205 may have first and second direction adjustment processors (speech processors) 204a and 204b that perform direction adjustment processing, and two hearing aid processors 204b and 204c and hearing aid processors 205b and 205c that each perform different hearing aid processing, for the two speech signals outputted from the speech input section 101 and the speech buffer 103, respectively.

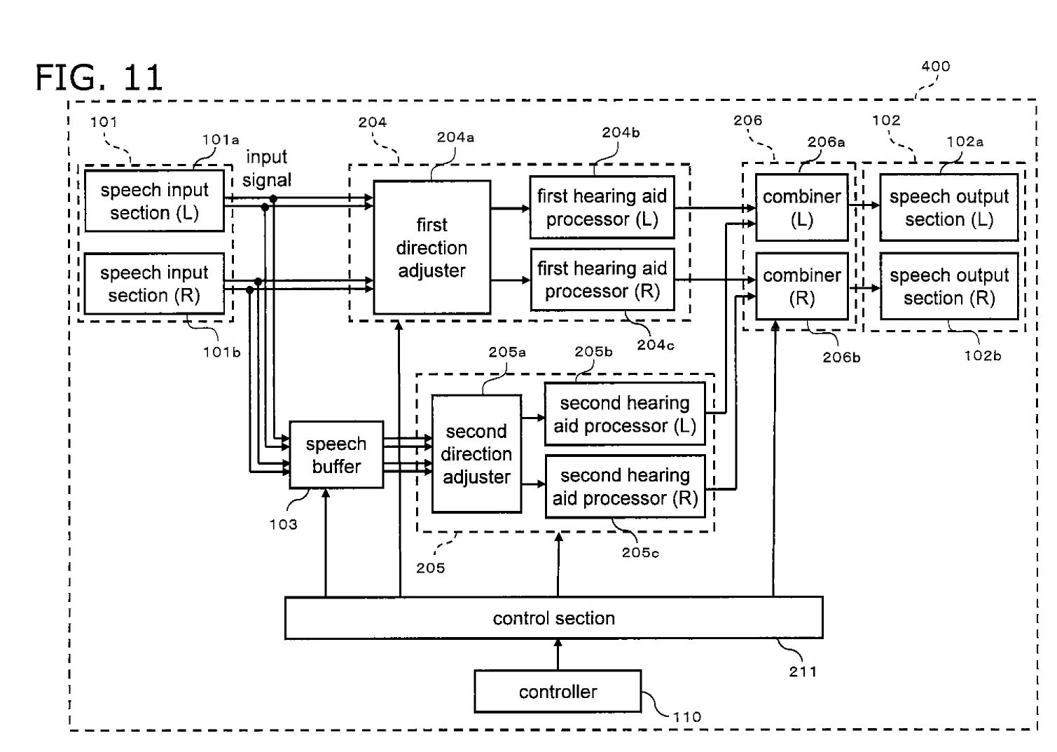

Also, if a plurality of (two in this embodiment) microphones are installed in the hearing aid 400, as shown in FIG. 11, the speech buffer 103 may record and output the plurality of speech signals outputted from the speech input sections 101a and 101b, and the first direction adjustment hearing aid processor 204 and the second direction adjustment hearing aid processor 205 may subject the plurality of speech signals outputted from the speech input section 101 and the speech buffer 103 to direction adjustment processing.

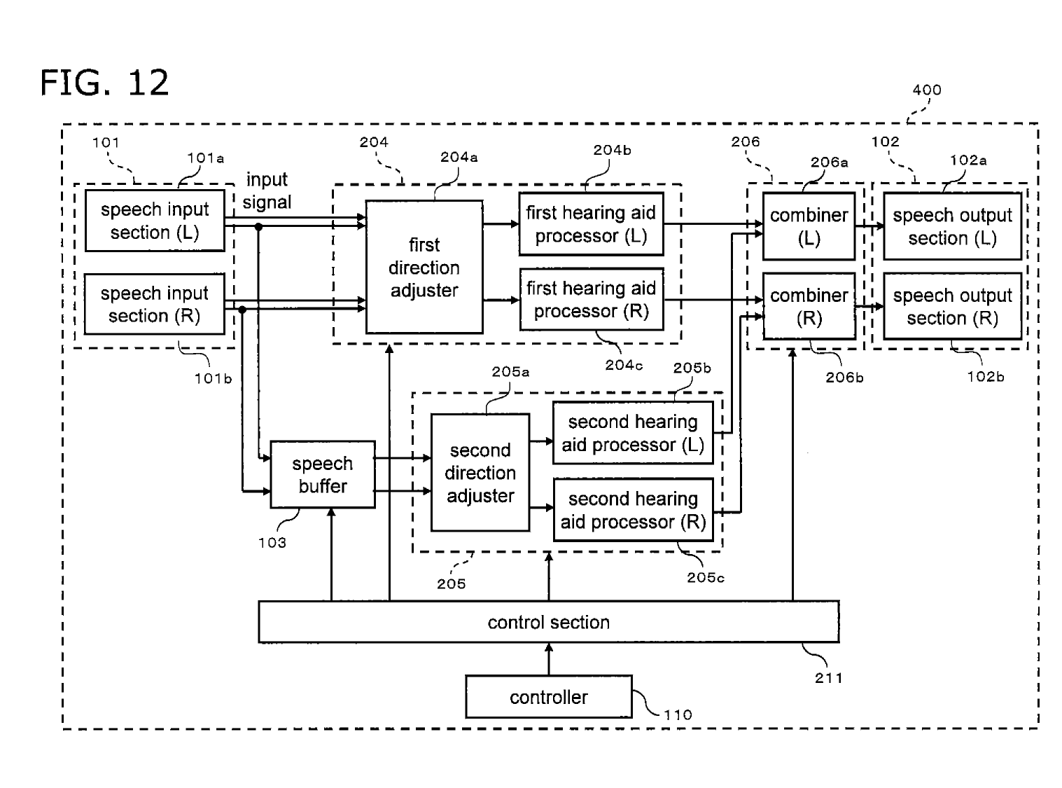

Further, if there is no need to perform directivity control processing on the recorded speech signals, as shown in FIG. 12, the speech buffer 103 may record and output one each out of the plurality of speech signals outputted from the speech input sections 101a and 101b.

### INDUSTRIAL APPLICABILITY

The hearing aid of the present invention is a hearing aid equipped with a recording function, with which it is possible to prevent the user from missing any new speech while listening again to recorded speech, and therefore can be widely applied to both binaural and monaural hearing aids.

### REFERENCE SIGNS LIST

10 user
100 hearing aid
100a button
101 speech input section
101a, 101b speech input section
102 speech output section
102a, 102b speech output section
103 speech buffer (speech memory section)
104 first direction adjuster (speech processor)
105 second direction adjuster (speech processor)
106 combiner
107 hearing aid processor
107a, 107b hearing aid processor
110 controller
111 control section
200 hearing aid
204 first direction adjustment hearing aid processor (speech processor)
204a first direction adjustment processor (speech processor)
204b first hearing aid processor
204c second hearing aid processor
205 second direction adjustment hearing aid processor (speech processor)
205a first direction adjustment processor (speech processor)
205b first hearing aid processor
205c second hearing aid processor
206 combiner
206a, 206b combiner
211 control section
300 hearing aid
400 hearing aid

1. A hearing aid, comprising:
a speech input section to which a speech signal is inputted;
a speech memory section configured to store a speech signal inputted to the speech input section;
a speech processor configured to subject a first speech signal inputted to the speech input section and/or a second speech signal stored in the speech memory section to speech processing such that the first speech signal and the second speech signal are each perceived independently;
a hearing aid processor configured to subject a signal outputted from the speech processor to hearing aid processing; and
a speech output section configured to output a speech signal that has undergone hearing aid processing at the hearing aid processor.

2. The hearing aid according to claim 1,
wherein the speech processor performs direction adjustment processing so that the first speech signal and the second speech signal are perceived by the user as being speech from different directions.

3. The hearing aid according to claim 2,
wherein the speech processor performs direction adjustment processing so as to subject the first speech signal to directional processing in the lateral direction, and subject the second speech signal to directional processing in the front or the rear direction.

4. The hearing aid according to claim 2,
wherein the direction adjustment processing includes directivity control processing in which sound is picked up with directionality in the desired direction.

5. The hearing aid according to claim 1,
wherein the speech processor performs volume adjustment processing so that the output level of the first speech signal will be lower than the output level of the second speech signal.

6. The hearing aid according to claim 1,
wherein the hearing aid processor subjects the first speech signal and the second speech signal each to different hearing aid processing.

7. The hearing aid according to claim 6,
wherein the hearing aid processor performs hearing aid processing so as to eliminate a noise part from the second speech signal.
